(19) United States
(12) Patent Application Publication
(10) Pub. No.: US 2026/0154872 A1
(43) Pub. Date: Jun. 4, 2026

(54) GENERATIVE IMAGE ALIGNMENT

(71) Applicant: GOOGLE LLC, Mountain View, CA (US)

(72) Inventors: Agoston Weisz, Zurich (CH); Vlad Ionescu, Zurich (CH)

(21) Appl. No.: 18/965,368

(22) Filed: Dec. 2, 2024

(51) Int. Cl. G06T 11/60

(52) U.S. Cl. CPC G06T 11/60

(57) ABSTRACT

Implementations disclosed herein relate to aligning generative image(s) with user request(s). For example, processor(s) of a system can: receive natural language input including a request to generate graphical content; generate graphical content based on processing generative model input (that includes at least a graphical content seed) using a generative model; and determine whether to render the graphical content based on processing critic model input (that includes the graphical content) using a critic model. Additionally, or alternatively, the processor(s) can: receive natural language input including a request to modify graphical content; generate modified graphical content based on processing generative model input (that includes at least a graphical content seed) using a generative model; and determine whether to render the modified graphical content based on processing critic model input (that includes the modified graphical content) using a critic model.

### BACKGROUND

Various generative model(s) (GM(s)) have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). As another example, image generation models have been developed that can be used to process NL content and/or other input(s), to generate visual outputs such as image data that is responsive to the input(s). Many of these GM(s) have multi-modal capabilities in that they are capable of receiving text-based inputs, graphical-based inputs, etc., and capable of generating text-based output, graphical-based outputs, etc.

While these GM(s) are capable of generating graphical-based outputs based on text-based input(s) and/or graphical-based input(s), many of the graphical-based output(s) generated using these GM(s) include artifact(s) that can undermine a purpose of using these GM(s). For example, assume a user provides a natural language input of “generate an image of a person giving the peace sign”. In this example, an artifact could include a person giving the peace sign with three fingers, a person giving the peace sign with two fingers but having six fingers on their hand, etc., such that these artifact is inconsistent with the natural language input. As another example, assume a user uploads an image and provides natural language input of “modify this picture so that the dog has a toy in its mouth”. In this example, an artifact could include a modification that disproportionately elongates the dog's face to accommodate the toy, such that the artifact is inconsistent with the natural language input.

Notably, generation and/or modification of graphical content that includes artifact(s) can increase consumption of computing resources and/or prolong human-to-computer dialogs. For example, if a user request to generate and/or modify graphical content results in graphical content that includes artifact(s), user will typically submit additional request(s) until the generated and/or modified graphical content is satisfactory, which, in turn, unnecessarily increases consumption of computing resources and results in longer human-to-computer dialogs.

### SUMMARY

Implementations disclosed herein enable accurate generation and/or modification of graphical content responsive to a natural language user input. For example, processor(s) of a system can: receive natural language input that is associated with a client device of a user and that includes a request to generate graphical content; generate, using a generative model, graphical content based on processing generative model input (that includes at least a graphical content seed that is determined based on the natural language input); and determine, using a critic model, whether to render the graphical content based on processing critic model input (that includes the graphical content).

In some implementations, the processor(s) can determine whether to render the graphical content based on whether the critic model indicates that the graphical content includes one or more artifacts that are inconsistent with the request to generate the graphical content. For instance, if the graphical content does not include any artifacts, then the processor(s) can determine to render the graphical content at the client device of the user. However, if the graphical content does include one or more artifacts, then the processor(s) can determine to refrain from rendering the graphical content at the client device of the user.

In some implementations, in response to determining to refrain from rendering the graphical content, the processor(s) can generate, using the generative model or an additional generative model, alternative graphical content based on processing additional generative model input (that includes at least an alternative graphical content seed, and that includes data indicative of one or more of the artifacts that are inconsistent with the request to generate the graphical content). Accordingly, the processor(s) can determine, using the critic model, whether to render the alternative graphical content, and in lieu of the graphical content, based on processing additional critic model input (that includes at least the alternative graphical content). The processor(s) can iteratively perform this process until the critic model indicates that suitable graphical content, that does not include any artifacts, is generated.

For example, a user may provide input “please generate an image of a person giving the peace sign”. The processor(s) can generate an image of a person giving the peace sign as graphical content, however the image may include an artifact (e.g., such as an extra thumb), which is inconsistent with a traditional display of the peace sign. Further, the processor(s) can process, using the critic model, the image of the person giving the peace sign and determine that the extra thumb is an artifact and, as a result, the processor(s) can determine to refrain from causing the image of the person giving the peace to be rendered at the client device. In response to determining that the graphical content includes the one or more artifacts, the processor(s) can determine data indicative of the one or more artifacts (e.g., extra thumb) and determine an alternative graphical content seed. Further, the processor(s) can generate an alternative image of a person giving the peace sign as alternative graphical content and using the data indicative of the one or more artifacts and the alternative graphical content seed. Assuming that the alternative image no longer includes the artifact (e.g., the extra thumb), then the alternative graphical content will be rendered.

In additional or alternative implementations, the processor(s) can: receive natural language input that is associated with a client device of a user and that includes a request to modify graphical content, generate modified graphical content based on processing generative model input (that includes at least a graphical content seed that is determined based on the natural language input and the graphical content) using a generative model, and determine whether to render the modified graphical content based on processing critic model input (that includes the modified graphical content) using a critic model.

In some implementations, the processor(s) can determine whether to render the modified graphical content based on processing the critic model input using the critic model to determine whether the modified graphical content includes one or more artifacts that are inconsistent with the request to modify the graphical content, and determine whether to render the modified graphical content based on whether the modified graphical content includes one or more of the artifacts that are inconsistent with the request to modify the graphical content.

In some implementations, in response to determining to render the modified graphical content, the processor(s) can cause modified graphical content to be rendered. In some implementations, in response to determining to refrain from rendering the modified graphical content, the processor(s) can cause alternative modified graphical content to be generated based on processing additional generative model input (that includes at least an alternative modified graphical content seed, and that includes data indicative of one or more of the artifacts that are inconsistent with the request to modify the graphical content) using the generative model or an additional generative model. In some implementations, processor(s) can determine whether to render the alternative modified graphical content based on processing additional critic model input (that includes at least the alternative modified graphical content) using the critic model. In some implementations, in response to determining to render the alternative modified graphical content, the processor(s) can cause the alternative modified graphical content to be rendered.

For example, a user may provide input “please modify this image of my friend [with each hand in a pants pocket] so that they are giving the peace sign”. The processor(s) can cause modified graphical content of the friend to be generated based on the image so that the person is now giving the peace sign, however the modified graphical content may include an artifact (e.g., such as an extra thumb), which is inconsistent with a traditional display of the peace sign. The processor(s) can process the modified graphical content using the critic model, and the processor(s) can determine that the modified graphical content includes the one or more artifacts. In response to determining that the modified graphical content includes the one or more artifacts, the processor(s) can apply data indicative of the one or more artifacts (e.g., extra thumb) and an alternative modified graphical content seed to the generative model or another generative model in furtherance of generating alternative modified graphical content. The processor(s) can cause alternative modified graphical content to be generated, and the alternative modified graphical content may include a graphic of the friend giving the peace sign without the artifact (e.g., the extra thumb), and may be consistent with a traditional display of the peace sign. The processor(s) can apply additional critic model input (including the alternative modified graphical content) to the critic model by the processor(s), and if the critic model does not recognize one or more artifacts included in the alternative modified graphical content, then the alternative modified graphical content may be rendered.

Although the above examples are described with respect to the artifact being an extra thumb in graphical content and modified graphical content that includes a person, it should be understood that is for the sake of example and is not meant to be limiting. Rather, it should be understood that the critic model can be trained to identify different artifacts for different types of images. For instance, in situations where the graphical content includes a request to generate and/or modify an image and/or video of a human, the critic model can identify artifacts that are typically associated with generative image(s) and/or video(s) of a human, such as extra fingers/toes, extra appendages, disproportionate appendages, misplaced appendages, and/or other graphical deviations from a graphical standard associated with humans. Also, for instance, in situations where the graphical content includes a request to generate and/or modify an image and/or video of an object, the critic model can identify artifacts that are typically associated with generative image(s) and/or video(s) of a objects, such as disproportionate size(s) of objects, illogical location(s) objects, illogical characteristic(s) of object(s), and/or other graphical deviations from a graphical standard associated with objects. Accordingly, it should be understood that not only can the critic model be utilized to identify these artifacts, but can adapt processing of the graphical content and/or the modified graphical content based on a type of request included in the natural language input.

By using various techniques disclosed herein, one or more technical advantages can be achieved. For example, the aforementioned problems related to inaccurate generation and/or modification of graphical content increasing unnecessary usage of computing resources and prolonging of human-to-computer dialogs may be resolved and/or mitigated based on iterative critique and regeneration (based on critique) of generative content. This reduces the likelihood and/or necessity for the user to provide additional inputs to correct artifact(s) which would consume additional computing resources. As another additional example, the aforementioned problem of the average user submitting one or more additional requests until the generated and/or modified graphical content is satisfactory may be resolved and/or mitigated based on iterative critique and regeneration (based on critique) of generative content - reducing extended and inconvenient user interactions for the computing resources to generate satisfactory graphical content.

The above description is provided as an overview of some implementations of the present disclosure. Further description of those implementations, and other implementations, are described in more detail below.

### BRIEF DESCRIPTION OF THE DRAWINGS

FIG. 1 depicts an example environment in which implementations discussed herein may be implemented.

FIG. 2 depicts a process flow associated with implementations discussed herein from a client device perspective, in accordance with various implementations.

FIG. 3 depicts another process flow associated with implementations discussed herein from a remote system perspective, in accordance with various implementations.

FIG. 4 depicts a flow chart associated with generation of graphical content, in accordance with various implementations.

FIG. 5 depicts a flow chart associated with modification of graphical content, in accordance with various implementations.

FIG. 6A depicts an environment in which a request to generate graphical content is received, in accordance with various implementations.

FIG. 6B depicts an environment in which a request to generate graphical content is received, and the graphical content is critiqued and alternative graphical content is generated, in accordance with various implementations.

FIG. 7A depicts an environment in which a request to modify graphical content is received, in accordance with various implementations.

FIG. 7B depicts an environment in which a request to modify graphical content is received, and the modified graphical content is critiqued and alternative modified graphical content is generated, in accordance with various implementations.

FIG. 8 depicts an example architecture of a computing device, in accordance with various implementations, in accordance with various implementations.

### DETAILED DESCRIPTION OF THE DRAWINGS

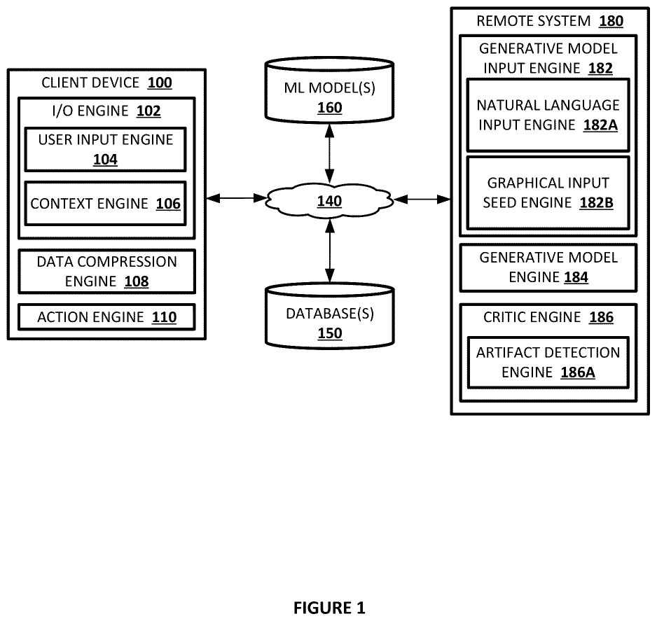

FIG. 1 depicts an example environment in which implementations discussed herein may be implemented. A client device 100 is illustrated in FIG. 1. Client device 100 may include one or more engines and/or be connected to one or more networks (e.g., network 140). For example, client device 100 may include I/O engine 102, user input engine 104, context engine 106, data compression engine 108, and/or action engine 110. Client device 100 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided. Further, network 140 may include, for example, any combination of Wi-Fi®, Bluetooth®, or other local area networks (LANs); ethernet, the Internet, or other wide area networks (WANs); and/or other networks.

In various implementations, I/O engine 102 may monitor, process, generate, and/or transmit one or more inputs and/or outputs. Inputs and/or outputs may be provided by and/or derived from a user and/or a computing device. I/O engine 102 may include user input engine 104 which may monitor, process, generate, and/or transmit one or more inputs that are provided by and/or derived from the user. Inputs may include spoken inputs captured in audio data generated by microphone(s) of client device 100, touch or typed inputs captured in generated by a touch sensitive display or other input component of client device 100, gesture inputs captured in vision data generated by vision component(s) of client device 100, and/or other inputs described herein. I/O engine 102 may monitor, process, generate, render, and/or transmit one or more outputs provided by and/or derived from the computing device and/or the user. Outputs may include graphical outputs rendered by a display of client device 100, audible outputs rendered by speaker(s) of client device 100, haptic outputs rendered by component(s) of client device 100, and/or other outputs.

In various implementations, context engine 106 may monitor, process, generate, and/or transmit contextual information provided by and/or derived from one or more users and/or computing devices, and/or using machine learning (ML) model(s) 160 described herein. For example, context engine 106 may process and/or generate historical user data, user preferences, location data, weather data, news data, etc., which may be applied to a machine learning model consecutively and/or concurrently with user input.

Applying contextual information with user input may result in improved generation and/or modification of content. Put another way, graphical content may be generated based on the user input and may also be generated based on contextual information. An example of this may be a request to “generate an image of a person holding this country's flag”. Contextual information, such as location, may be used to provide accurate graphical content responsive to the user request. Using the aforementioned example, if the person is in the United States, then the graphical content may include the United States flag, and if the person is in another country, then the graphical content may include the other country's flag. Context engine 106 may also generate and/or process data using third party applications. For example, if graphical content (e.g., a bird bath) and a request to (“render an image of that bird in this bird bath”) are captured concurrently, contextual information (such as background noise including a particular bird call) may be used in furtherance of modifying the graphical content, and a third party bird identification application (and/or a third party general browser application) may be used in furtherance of providing modified graphical content corresponding the bird captured in the background noise.

In various implementations, data compression engine 108 may compress data transmitted to other systems (in whole and/or in part), such as data transmitted to remote system 180. Compression of data by data compression engine 108 may reduce a transferrable size of data relative to a non-compressed transferrable size of data. Correspondingly, compression of data may further reduce computational and network strain associated with transmission and processing of large amounts of data, such as graphical data.

In various implementations, action engine 110 may cause one or more actions to be performed by client device 100 and/or another computing device. Action engine 110 may cause an action to occur based on processing data, including data generated and/or received by client device 100. For example, if client device 100 generates and/or receives graphical content data, then action engine 110 may cause graphical content to be rendered at one or more interfaces of client device 100 and/or another device based on the graphical content data. As another example, action engine 110 may cause an automated assistant to perform one or more actions based on graphical content, such as rendering music that corresponds to the graphical content, modifying one or more lights while the graphical content is being rendered, etc.

Network 140 may connect client device 100 with other components that are also connected to network 140. Other components may be connected via network 140 and may or may not be directly connected to client device 100. Other components may include database(s) 150, ML model(s) 160, and remote system 180. Components included in network 140 (including client device 100) may be constantly or periodically connected to network 140. Data transmitted over network 140 may be temporarily stored. For example, client device 100 may temporarily connect to network 140, transmit data over network 140, and disconnect from network 140, and the transmitted data may be temporarily stored (e.g., by instruction from client device 100 or by instruction from one or more other components connected to network 140). Adding to this example, subsequent to client device 100 transmitting data and disconnecting from network 140, remote system 180 may connect to network 140, and the temporarily stored data may be transmitted to remote system 180. Some components connected to network 140 may only be accessible by an exclusive subset of other components on network 140. For example, ML models 160, while on network 140, may only be accessible by remote system 180 and may not be accessible by client device 100, despite both remote system 180 and client device 100 both being on network 140. Additionally, or alternatively, an instance of the ML models 160 may be stored locally in memory of client device 100.

Network 140 may be connected to one or more databases 150. Database(s) 150 may also include a remote system database, which may identify various remote systems and respective capabilities, and which may be used to identify an appropriate remote system to which client device 100 may transmit data. For example, it may be determined that remote system 180 is the most capable remote system of a plurality of available remote systems, based on one or more criteria, such as bandwidth, remote system activity, remote system hardware and software, etc. Database(s) 150 may also include search engines, which may be used, for example, to perform a search action based on a signed natural language input.

Network 140 may provide access to one or more ML models 160. ML models 160 may include a model that is trained to output at least graphical content in response to application of user input data and/or contextual data to the model. The model may be trained based on user input data, context data, and/or graphical content data. Machine learning models 160 may include machine learning models that are connected to databases 150 via network 140. ML models 160 may include models that are trained based on databases 150.

Remote system 180 (e.g., a high performance server or a cluster of high performance servers) may be connected to network 140 via which remote system 180 and client device 100 may interact. Remote system 180 may include generative model input engine 182, natural language input engine 182A, graphical input seed engine 182B, generative model engine 184, critic engine 186, and/or artifact detection engine 186A. Although remote system 180 is depicted as including these engines, it should be understood that is for the sake of example and is not meant to be limiting. For example, in additional or alternative implementations, these engines can be executed locally at client device 100. As another example, in additional or alternative implementations, one or more of these engines can be executed remotely from client device 100 (e.g., by remote system 180) and one or more of these engines can be executed locally at client device 100 in a distributed manner.

In various implementations, generative model input engine 182 may handle requests received by remote system 180. For example, generative model input engine 182 may handle requests received from client device 100, such as a natural language request to generate and/or modify graphical content. Generative model input engine 182 may determine whether or not to handle a particular request. A determination of whether or not to handle a particular request may be based on one or more factors, such as bandwidth, available processing capabilities, time of day, client devices currently being served or expected to be served, client device location, data size, etc.

Further, generative model input engine 182 may receive and/or facilitate processing of contextual data which may be initially processed and/or generated using context engine 106 prior to being transmitted from client device 100 over network 140 to remote system 180. Processing of contextual data by generative model input engine 182 may bias one or more of natural language input engine 182A and/or graphical input seed engine 182B. Generative model input engine 182 may generate seed data which may be based on output generated by one or more of natural language input engine 182A and/or graphical input seed engine 182B.

As noted above, generative model input engine 182 may include natural language input engine 182A. Natural language input engine 182A may generate one or more tokens based on data from I/O engine 102 and/or context engine 106. For example, natural language input engine 182A may generate the one or more tokens based on natural language input (e.g., “generate an image including this particular feature”) that a user provided via client device 100, and which may have been processed by I/O engine, and may optionally generate the one or more tokens based on any relevant context determined by context engine 106.

Moreover, generative model input engine 182 may include graphical input seed engine 182B. Graphical input seed engine 182B may generate or determine one or more graphical content seeds based on natural language input and/or graphical input that is provided by the user. For example, graphical input seed engine 182B may generate or determine one or more seeds based on an image, video, etc., that a user selected and/or captured via client device 100, and that may have also been accompanied with a natural language input (e.g., “modify this picture to include a particular feature”).

In various implementations, generative model engine 184 may process generative model input, which may be derived at least in part from generative model input engine 182. Generative model engine 184 may also process data that is derived from database(s) 150 and/or ML model(s) 160. For example, in processing generative model input, generative model engine 184 may utilize database(s) 150 and/or ML model(s) 160 to generate generative model output data. Put another way, generative model input engine 182 may apply generative model input data to machine learning model(s) 160 in furtherance of generating generative model output data. Generative model input engine 182 may also transmit data to and/or receive data from database(s) 150 in furtherance of generating generative model output data.

As described herein, a generative model can be any sequence-to-sequence based ML model capable of generating generative vision data, generative audio data, generative textual data, and/or other forms of generative data. Some non-limiting examples of sequence-to-sequence based ML models that are capable of generating one or more forms of the generative data noted above include transformer-based ML models (e.g., encoder-decoder transformer models, encoder-only transformer models, decoder-only transformer models, etc. that optionally employ an attention mechanism or some other form of memory), stable diffusion-based ML models, recurrent neural network-based ML models, generative adversarial network-based ML models, etc. Various sequence-to-sequence based ML models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based ML models that have demonstrated multimodal capabilities include the Gemini family of models, the ChatGPT family of models, the Claude family of models, the Llama family of models, and/or other families of sequence-to-sequence generative models.

In various implementations, critic engine 186 may process generative model output data in furtherance of identifying whether the generative model output data (and/or an graphical content that may be rendered based on processing the generative model output data) may include one or more artifacts (e.g., corruptions, inconsistencies that are illogical or do not conform with a request, etc.). Critiquing the generative model data may include identifying inaccuracies and/or inconsistencies in the generative model output data itself, and/or identifying generative model output data that could cause inconsistencies and/or inaccuracies when processed in furtherance of generating and/or rendering graphical content. For example, critic model engine 186 may critique whether generative model output data itself includes inaccuracies and/or inconsistencies (e.g., inexecutable data, incompatible data, corruptions, etc.). As another example, critic model engine 186 may critique whether generative model output data could cause inaccuracies (e.g., extra fingers, disproportionately long noses, etc.) when processed in furtherance of generating and/or rendering graphical content (e.g., an image being rendered for a user at one or more interfaces of client device 100). Critic engine 186 may be used to analyze whether generative model output data corresponds with a user request, user preferences, location settings, current events, etc.

In particular, artifact detection engine 186A, which may be used to determine whether one or more artifacts exist in the generative model output data. An artifact may include an inconsistency and/or inaccuracy in the generative model output data that may cause graphical content to be rendered that is inconsistent with a user request (e.g., generating a hand with extra fingers in response to a user request to “generative a graphic of a person holding a peace sign”). Artifacts may differ from other issues, such as corruptions, in that while data including a corruption may correspond with one or more inexecutable aspects (e.g., one or more portions of an image may not be generated based on corrupted data), artifacts may include executable aspects that cause a graphic to be rendered with an inconsistency and/or inaccuracy (e.g., all aspects of an image may be generated, but the image includes disproportionate and/or include non-traditional features that are inconsistent with a natural language request to generate and/or modify the image). Notably, remote system 180 may use critic model engine 186 and/or artifact detection engine 186A to process, using a critic model as one of ML model(s), generative model output data and identify whether graphical content (that may be rendered at a client device) includes one or more artifacts (e.g., non-traditional anatomical features, such as extra fingers on a hand) that may cause the graphical content to be inaccurate and/or inconsistent. If critic model engine 186 and/or artifact detection engine 186A determines that graphical content includes one or more artifacts, then critic model engine 186 and/or artifact detection engine 186A can cause alternate graphical content to be generated.

As described herein, a critic model that is utilized critic model engine 186 and/or artifact detection engine 186A can include any ML model or ML classifier that is trained to identify artifacts and/or other inconsistencies in graphical content and/or in modified graphical content. For example, the critic model can be the generative model (e.g., that was utilized to generate the graphical content), another generative model (e.g., that is in addition to the generative model that was utilized to generate the graphical content, such as a visual language model (VLM)), and/or another ML-based model or classifier. Prior to receiving any user input, the critic model can be trained to identify these artifacts and/or other inconsistencies in graphical content and using different learning techniques, such as supervised fine-tuning (SFT), reinforcement learning from human feedback (RLHF), and/or other learning techniques.

For example, and in using SFT to train the critic model, remote system 180 can obtain a plurality of SFT training instances. Each of the plurality of SFT training instances can include training graphical content and ground truth output. Further, remote system 180 can process, using the critic model, critic model input (e.g., including at least the training graphical content) to generate critic model output and determine, based on comparing the critic model output to the ground truth output, an update for the critic model. Remote system 180 can repeat this training process until one or more conditions are satisfied for causing the critic model to be deployed (e.g., the critic model achieves a threshold level of performance, the critic model has been trained for a threshold duration of time, the critic model has been trained on a threshold quantity of training instances, etc.). For instance, assume that the training graphical content includes an image of a water bottle on a desk, but the water bottle is disproportionately large relative to other items on the desk. In this instance, remote system 180 can process, using the critic model, critic model input, that includes at least the image of the water bottle on the desk, to generate critic model output. The critic model output can include an indication of whether there are any artifacts in the image and compare the critic model output to the ground truth output (e.g., indicating that the water bottle is disproportionately large relative to other items on the desk) to generate loss(es) for the critic model and the loss(es) can be backpropagated across the critic model to update the critic model.

Notably, the ground truth output can be, for example, natural language output indicating that the water bottle is disproportionately large, a bounding box around the water bottle that is disproportionately large and indicating that is an artifact or inconsistency, a probability below a threshold indicating that the image includes an artifact or inconsistency, and/or other forms of ground truth output. Further, the critic model output that is generated can be based on the ground truth output in that the critic model can be instructed to generate the critic model output that conforms with a type of the ground truth output. This instruction can be included, for instance, in the critic model input.

As another example, and in using RLHF to train the critic model, remote system 180 can utilize a separate reward model to generate a reward for the critic model and based on input received from a human reviewer that evaluates the image. For instance, assume that graphical content is provided for presentation to the human reviewer. In this instance, the human reviewer can provide a “thumbs up” or other natural language input that indicates the graphical content does not include any artifacts, inaccuracies, etc., and remote system 180 can utilize the reward model to generate a “positive” reward that can be utilized to update the critic model. Also, for instance, the user can provide a “thumbs down” or other natural language input that indicates the graphical content does include artifacts, inaccuracies, etc., and remote system 180 can utilize the reward model to generate a “negative” reward that can be utilized to update the critic model.

Although the above description of the critic model is described with respect to training a single critic model, it should be understood that is for the sake of example and is not meant to be limiting. For example, in some implementations, a single can be trained to identify artifacts across all images as described above. However, in additional or alternative implementations, it should be understood that multiple disparate critic models can be trained to identify particular artifacts for different types of image(s) and/or video(s). For instance, a first critic model can be trained to identify particular artifacts for image(s) and/or video(s) that include human(s), a second critic model can trained to identify particular artifacts for image(s) and/or video(s) that include object(s) but not human(s), and so on. In these additional or alternative implementations, remote system 180 can optionally select a particular critic model, from among the multiple disparate critic models, to process the graphical content and/or the modified graphical content based on the natural language input, based on content included in the graphical content and/or the modified graphical content, and/or based on other factors.

Client device 100 and/or remote system 180 may include one or more memories for storage of data and software applications, one or more processors for accessing data and executing the software applications, and other components that facilitate communication over networks 140.

Although FIG. 1 is depicted as including client device 100, remote system 180, and respective engines for client device 100 and remote system 180, it should be understood that is for the sake of example to illustrate various techniques contemplated herein and is not meant to be limiting. For example, one or more additional client devices can also be connected over network 140 to form an ecosystem of devices. Further, one or more engines of client device 100 can be added, combined, or omitted. Moreover, one or more engines of remote system 180 can be added, combined, or omitted.

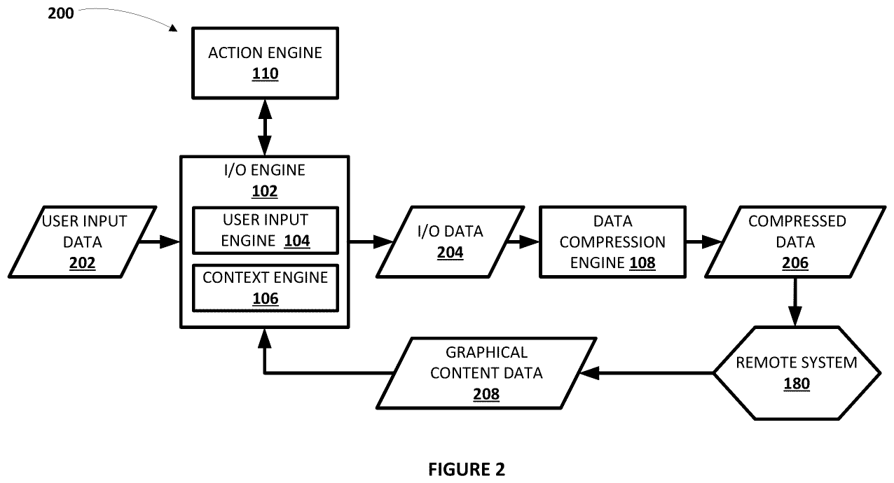

FIG. 2 depicts a process flow associated with implementations discussed herein from a client device perspective, such as from the perspective of client device 100 discussed above with respect to FIG. 1. User input data 202 may be received by user input engine 104 of I/O engine 102. User input data 202 may include visual, audible, and/or haptic input. User input data 202 may be identified by client device 100 or another device. For example, client device 100 may identify user input data 202 based on input detected by a touch sensitive display, camera(s), microphone(s), and/or haptic sensor(s). As another example, client device 100 may identify user input data 202 based on communication with another device (such as a third party device, wearable computing device, mobile device, etc.) that may be capable of receiving user input.

I/O engine 102 may receive and/or process user input data 202. As discussed previously, I/O engine 102 may manage input and output of data of client device 100. For example, I/O engine 102 may process the user input data 202 and may identify and/or generate output that may include I/O data 204. Further, I/O engine 102 may also include user input engine 104, which may process user input data 202. User input engine 104 may include one or more models that are capable of processing natural language input and identifying and/or generating an output that may be processed by one or more models of the system responsive to receiving the user input data. For example, one or more models of the systems disclosed herein may or may not be capable of processing natural language user input, and user input engine 104 may identify and/or generate an output (based on user input data 202) that is capable of being processed by models that are otherwise not capable of processing the natural language user input. Moreover, I/O engine 102 may also include context engine 106 that may generate and/or identify contextual data associated with user input data 202. For example, context engine 106 may identify and/or generate user preference data, location data, current events data, etc., that may be associated with user input data 202.

I/O data 204 may be output by I/O engine 102, and may include data generated by and/or derived from user input engine 104 and/or context engine 106. For example, I/O data 204 may include data from user input engine 104, which may provide computer-processable data that is indicative of the natural language features of the user input data 202. As another example, I/O data 204 may include data from context engine 106, which may provide contextual information such as user preferences, user location, current events data, etc. I/O engine 102 may process data generated by user input engine 104 and context engine 106, and may generate I/O data 204 based on processing data generated by user input engine 104 and context engine 106.

Data compression engine 108 may receive I/O data 204. Data compression engine 108 may cause I/O data 204 to be compressed. Data compression engine 108 may cause I/O data 204 to be compressed using various techniques, including transform coding, run-length coding, Huffman coding, and/or other suitable data compression techniques. Compression of I/O data 204 may anonymize personally identifying characteristics of a user providing user input based on coding and/or recoding of I/O data 204 during various compression techniques. Compression of I/O data 204 may also reduce consumption of computational resources used in processing and communicating I/O data 204, based on compressed data being of a reduced file size. Compression of the I/O data 204 may also reduce network latency and consumption of network resources, as transmitting compressed (e.g., reduced file size) data may be faster than transmitting non-compressed data. In other implementations, the data compression engine 108 may be omitted.

Compressed data 206 may be generated by data compression engine 108. Compressed data may be of a smaller file size than non-compressed data. Additionally, or alternatively, compressed data may also be of less complexity than non-compressed data based on the compression techniques used to generate the compressed data. Compressed data 206 may be sent to remote system 180. For instance, compressed data 206 may be sent to remote system 180 in addition to and/or lieu of other input, content, and/or data illustrated in process 200, including user input data 202 or I/O data 204, etc. In some implementations, transmission of data between client device 100 and remote system 180 may be staggered such that compressed data 206 is sent first and non-compressed data may be sent later based on a temporal considerations (e.g., passage of time) and/or request from remote system 180 for non-compressed data. In various implementations, data compression engine 108 can be omitted such that user input data 202 and/or I/O data 204 is transmitted to remote system 180 in lieu of compressed data 206.

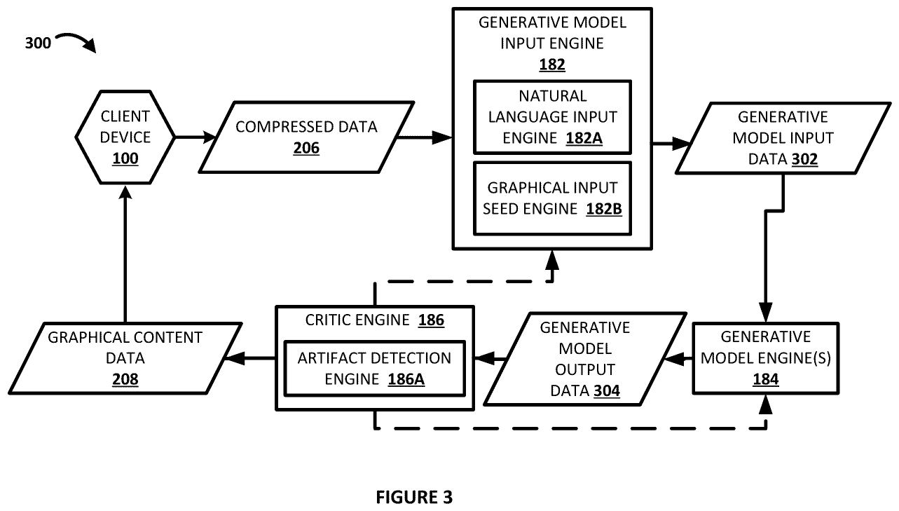

Remote system 180 may receive compressed data 206 (or user input data 202 and/or I/O data 204 when the data compression engine 108 is omitted). Compressed data 206 may be transmitted from client device 100 (depicted in FIG. 1, and discussed previously). Client device 100 may transmit compressed data 206 to remote system 180 over one or more networks 140. Remote system 180 may process compressed data 206. Techniques that are more specific to remote system 180 will be discussed subsequently, for example, in the detailed description of FIG. 3.

Graphical content data 208 may be identified and/or received by client device 100. For example, graphical content data 208 may be identified and/or received by I/O engine 102. Graphical content data 208 may be received by client device 100 from remote system 180. Graphical content data 208 may indicate graphical content that may be rendered based on processing the graphical content data 208 from remote system 180. Graphical content data 208 may be generated by remote system 180 based on compressed data 206 (and/or one or more of I/O data 204 and/or user input data 202) being transmitted from client device 100 to remote system 180.

Action engine 110 may receive graphical content data 208 and/or data derived from graphical content data from I/O engine 102. Action engine 110 may generate an instruction for an action to be performed based on data received. For example, the graphical content data 208 may correspond with the user input data 202 that includes a natural language request for generation and/or modification of graphical content. Action engine 110 may generate an instruction to cause the generated and/or modified graphical content to be rendered based on data received (e.g., based on graphical content data 208) or process an instruction received from remote system 180 to cause the generated and/or modified graphical content to be rendered based on data received (e.g., based on graphical content data 208). I/O engine 102 may receive the instruction from action engine 110 to cause the generated and/or modified graphical content to be rendered. I/O engine 102 may generate an output that causes the generated and/or modified graphical content to be rendered at one or more interfaces of client device 100 and/or another device (e.g., a display of client device 100).

FIG. 3 depicts a process flow associated with implementations discussed herein from a remote system perspective, such as from the perspective of remote system 180 discussed above with respect to FIG. 1. The process flow is based on process 300.

Remote system 180 may be in communication with client device 100. Remote system 180 and client device 100 may communicate over network(s) 140. Compressed data 206 may be identified and/or received by remote system 180. Compressed data 206 may be received by remote system 180 from client device 100. Compressed data 206 may include and/or be accompanied by a request from client device 100 for remote system 180 to process the compressed data 206. In various implementations, data compression engine 108 can be omitted such that user input data 202 and/or I/O data 204 is received by remote system 180 in lieu of compressed data 206.

Generative model input engine 182 may determine what features are included in a request associated with compressed data 206 (or user input data 202 and/or I/O data 204). Generative model input engine 182 may determine whether to handle a request associated with compressed data 206 (or user input data 202 and/or I/O data 204). For example, generative model input engine 182 may determine whether to accept or decline a request to process compressed data 206. As another example, generative model input engine 182 may determine how to handle a request associated with compressed data 206. As yet another example, generative model input engine 182 may determine when to handle a request associated with compressed data 206.

Generative model input engine 182 may include natural language input engine 182A. Natural language input engine 182A may generate one or more tokens corresponding to a natural language input captured by user input data 202, which may be used by generative model engine(s) 184 to generate generative model output data 304. Generative model input engine 182 may also include graphical input seed engine 182B. Graphical input seed engine 182B may generate one or more graphical input seeds, which may be used by generative model engine(s) 184 to generate generative model output data 304. In some implementations, only one or more of natural language input engine 182A or graphical input seed engine 182B may be utilized. For example, in some implementations a user may only provide natural language input, and only natural language input engine 182A may be used (e.g., for a text summarization task, a text generation task, etc.). As another example, in some implementations a user may only provide a graphical input, and only graphical input seed engine 182B may be used. Generative model input engine 182 may generate generative model input data 302, which may be provided as input to generative model engine(s) 184.

Generative model input data 302 may include data generated by and/or derived from one or more of natural language input engine 182A and/or graphical input seed engine 182B. Generative model input data 302 may be received by generative model engine(s) 184. Generative model engine(s) 184 may include one or more engines that may process, using generative model(s), generative model input data 302 and generate generative model output data 304 based on generative model input data 302. Generative model engine(s) 184 may include one or more models capable of generating generative model output data 304, which may be processed in furtherance of rendering graphical output in response to natural language input that is received from a user of client device 100 and/or graphical input that is received from a user of client device 100.

Critic engine 186 may receive generative model output data 304. Critic engine 186 may critique generative model output data 304 (e.g., to identify any inaccuracies and/or inconsistencies thereof) using, for instance, a critic model (e.g., as described with respect to FIG. 1). For example, critic engine 186 may identify whether generative model output data 304 includes invalid data, corrupted data, inexecutable data, incompatible data, etc. Critic engine 186 may identify whether generative model output data 304 corresponds to a particular device, OS, version, etc. Critic engine 186 may include artifact detection engine 186A, which may identify whether processing of generative model output data 304 may result in graphical content being rendered that includes one or more artifacts (e.g., inaccuracies and/or inconsistencies). If critic engine 186 (and/or artifact detection engine 186A) identifies one or more issues (e.g., artifacts, corruptions, etc.), then data indicative of the one or more issues may be applied to one or more of generative model input engine 182 (in which case, alternative generative model seeds may be generated or determined) and/or generative model engine(s) 184 (in which case, generative model engine(s) 184 may be biased based on the data).

For example, if critic engine 186 (and/or artifact detection engine 186A) identify one or more issues then critic data indicative of the one or more issues may be applied to generative model input engine 182. The critic data indicative of the one or more issues may bias generative model input engine 182, natural language input engine 182A, and/or graphical input seed engine 182B, and may therefore cause alternative generative model input data 302 to be generated. Put another way, graphical input seed engine 182B may have originally generated or determined a seed that resulted in extra and/or disproportionate appendages, and data indicative of the one or more issues may bias graphical input seed engine 182B to generate or determine an alternative seed. In some implementations, multiple iterations of generative model output data 304 may be received and/or processed by critic engine 186 (and/or artifact detection engine 186A) until it is determined that issues (e.g., corruptions, artifacts, etc.) fall below a threshold. A threshold may be determined based on user data, aggregation of user data, etc.

Metrics may be assigned to particular issues. Identifying whether generative model output data 304 satisfies a threshold may be based on determining whether an aggregation of one or more issues that may be included in generative model output data 304 satisfies a threshold. Put another way, identifying whether generative model output data 304 satisfies a threshold may be based on determining whether an aggregation of all issues (e.g., regardless of issue type, such as corruption, artifacts, etc.) included in generative model output data 304 satisfies a threshold. As another example, identifying whether generative model output data 304 satisfies a threshold may also be based on determining whether an aggregation of one or more issue types (e.g., corruptions, artifacts, etc.) satisfy a threshold, wherein each issue type may have an associated weight. Put another way, generative model output data 304 may include one or more artifacts of a first type (e.g., distorted colors, saturation, etc.) but may not include one or more artifacts of a second type (e.g., non-traditional anatomical features), and may satisfy a threshold based on it not having the one or more artifacts of the second type (given a higher weight), even though it may have one or more artifacts of the first type (given a lower weight).

Graphical content data 208 may be transmitted from remote system 180 to client device 100 in response to critic engine 186 (and/or artifact detection engine 186A) determining that issues of generative model output data 304 fall below a threshold. Graphical content data 208 may include generative model output data 304. Graphical content data 208 may also include one or more other data, such as critic model feedback data, compressed data indicative of generative model output data 304, etc. Remote system 180 may determine to transmit graphical content data to client device 100.

Although process 200 of FIG. 2 and process 300 of FIG. 3 depict certain operations, it should be understood that is for the sake of example and is not meant to be limiting. For example, in additional or alternative implementations, operations depicted in process 200 of FIG. 2 and process 300 of FIG. 3 can all be executed at client device 100.

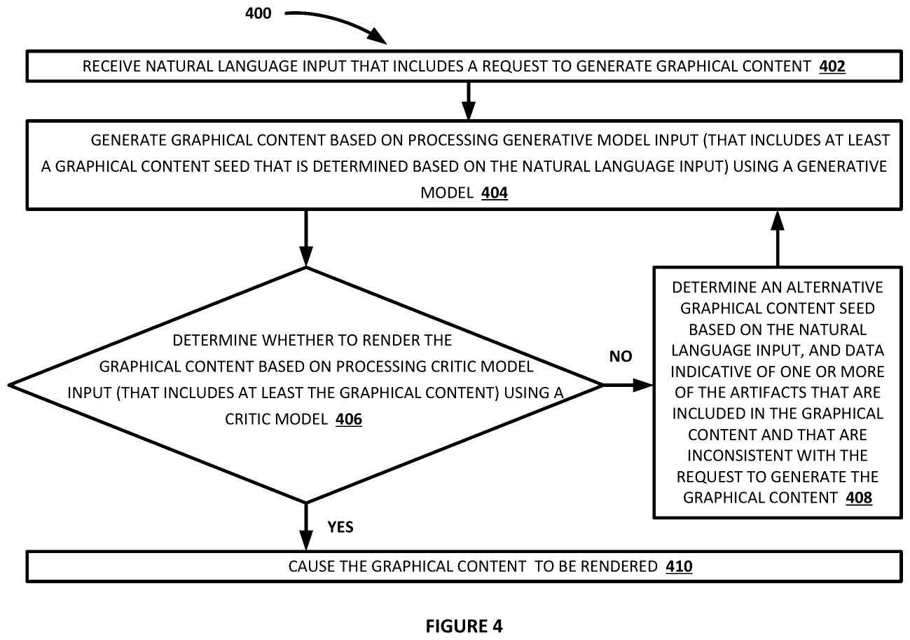

FIG. 4 depicts a flow chart 400 associated with implementations discussed herein. Aspects of flow chart 400 may be performed by a system that may include one or more components, such as client device 100, remote system 180, and/or another computing device. While operations of flow chart 400 are shown in a particular order, this is not meant to be limiting. One or more operations may be reordered, omitted, and/or added.

At step 402, the system receives natural language input that includes a request to generate graphical content. For example, client device 100 may receive user input data 202 at I/O engine 102. As discussed in previous Figures (such as FIG. 2), client device 100 may also process and/or compress aspects of user input data 202. The user input may include visual, haptic, and/or audio characteristics. For example, the system may capture a first portion of user input that is visually provided via a camera and the client device may capture a second portion of user input that is audibly provided via a microphone. User input may also be captured prior to invoking an automated assistant and selected subsequent to invoking the automated assistant.

At step 404, the system generates graphical content based on processing generative model input (that includes at least a graphical content seed that is determined based on the natural language input) using a generative model. A graphical content seed may be generated or determined based on application of data (indicative of a user input and/or the graphical content seed) over a generative model. For example, as discussed in FIGS. 2 and 3, generative model input engine 182 may receive compressed data 206 and/or user input data 202 received at I/O engine 102. Generative model input data 302 may include a graphical content seed that is determined based on at least the compressed data 206 and/or user input data 202. Generative model engines 184 may process generative model input data 302, which may include a graphical content seed. Generative model engine(s) 184 may generate generative model output data 304, which may include graphical content (and/or data that may be executed and/or processed in furtherance of rendering graphical content).

At step 406, the system determines whether to render the graphical content based on processing critic model input (that includes at least the graphical content) using a critic model. If the system determines that the graphical content should be rendered, then flow chart 400 proceeds to step 410, and the system causes the graphical content to be rendered. For example, generative model output data 304 may be provided to critic engine 186 (and/or artifact detection engine 186A). If no issues (e.g., corruptions, artifacts, etc.) are identified by the critic engine 186, then graphical content data 208 (which may include generative model output data 304 and/or additional data) may be transmitted to client device 100. Remote system 180 may transmit graphical content data 208 to I/O engine 102 of client device 100, and I/O engine 102 may provide graphical content data 208 to action engine 110 which may cause graphical content (derived from graphical content data 208) to be rendered via one or more interfaces of client device 100 and/or another client device.

In some implementations, the system determines that the graphical content should not be rendered, and flow chart 400 proceeds from step 406 to step 408. For example, generative model output data 304 may be provided to critic engine 186 (and/or artifact detection engine 186A). If issues (e.g., corruptions, artifacts, etc.) are identified by the critic engine 186 and/or artifact detection engine 186A, then the system may determine that graphical content should not be rendered. Further, if issues (e.g., corruptions, artifacts, etc.) are identified by the critic engine 186 and/or artifact detection engine 186A, then critic engine 186 may transmit data (which may include generative model output data 304, data indicating the issues, etc.) back to generative model input engine 182 and/or generative model engines 184. For example, critic engine 186 may provide generative output data 304—and/or data indicating issues included in generative output data 304 and/or issues that will be included in graphical content that may be rendered based on processing of generative output data 304—to generative model input engine 182 and/or generative model engine(s) 184. Generative model input engine 182 may generate alternative generative model input data 302, including an alternative graphical content seed, based on the natural language input, and based on the data received from critic engine 186.

Subsequent to performing features of step 408, flow chart 400 may proceed back to step 404. However, based on step 408 being performed, step 404 may be performed using the alternative graphical content seed in addition to and/or in lieu of a previously generated graphical content seed, and step 404 may be performed in furtherance of generating alternative graphical content in lieu of the previously generated graphical content. For example, alternative graphical content may be generated based on processing generative model input that includes the alternative seed data. In some implementations, generative model engine 184 may also receive data from critic engine 186 (e.g., either directly, and/or vicariously via alternative generative model input data 302), and may be updated, biased, and/or trained, etc., based on the data received from critic engine 186. Put another way, critic engine 186 may provide data that may be used in furtherance of generating or determining alternative seed data, and/or which may also be used in furtherance of training generative model(s).

Steps 404, 406, and/or 408 may be performed one or more additional times. By iteratively critiquing generative model output data 304, and/or updating generative model input data 302 and/or generative model engine 184, graphical content may be generated more accurately, and unnecessary usage of computing resources and prolonging of human-to-computer dialogs may be resolved and/or mitigated. This reduces the likelihood and/or necessity for a user to provide additional inputs (thus re-initiating the whole of flow chart 400) to correct artifact(s)—which would consume additional computing resources, such as those of client device 100 and/or remote system 180. As another example, the aggregate of users submitting one or more additional requests until the generated and/or modified graphical content is satisfactory may be resolved and/or mitigated based on iterative critique and regeneration (based on critique) of generative content—reducing extended and inconvenient user interactions that consume computing resources in furtherance of generating satisfactory graphical content.

As discussed above, during step 410 the system causes graphical content to be rendered. The system may cause the graphical content to be rendered based on a determination to render the graphical content (based on processing critic model input, that includes at least the graphical content, using a critic model), per step 406. The graphical content to be rendered may change based on processing of critic model input. Put another way, each iteration of steps 404 and/or 408 may result in data being generated, which when processed, may cause particular and distinct graphical content to be rendered. For example, a first iteration of graphical content (if rendered) may include a person holding a peace sign and having two extra fingers and a disproportionately long nose (e.g., two artifacts), a second iteration of graphical content (e.g., alternative graphical content) may include the person holding the peace sign and having only one extra finger and a traditionally proportionate nose (e.g., one artifact), and a third iteration of graphical content (e.g., additional alternative graphical content) may include the person holding the peace sign (e.g., no artifacts). In some implementations, step 410 may include remote system 180 transmitting graphical content data to client device 100, which may receive the graphical content data 208 at I/O engine 102 and may cause graphical content to be rendered via one or more interfaces based on provision of graphical content data 208 being provided to action engine 110.

Although FIG. 4 depicts the flow chart 400 being executed for any natural language input that includes a request to generate graphical content, it should be understood that is for the sake of example and is not meant to be limiting. For example, the operations of FIG. 4 may only be executed in certain situations, such as when the natural language input includes a request for realistic graphical content. For instance, had the natural language input included a request to generate graphical content including an alien or other science fiction topic, then the steps of 406 and 408 may be omitted such that an image of an alien having six fingers and an elongated nose could be rendered. In these implementations, the system can optionally use a ML-based classifier or other approach to determine whether to include the steps of 406 and 408. Additionally, or alternatively, one or more terms included in the user input can explicitly override utilization of the ML-based classifier (e.g., user input that states “include a person with six fingers” can override utilization of the ML-based classifier, etc.).

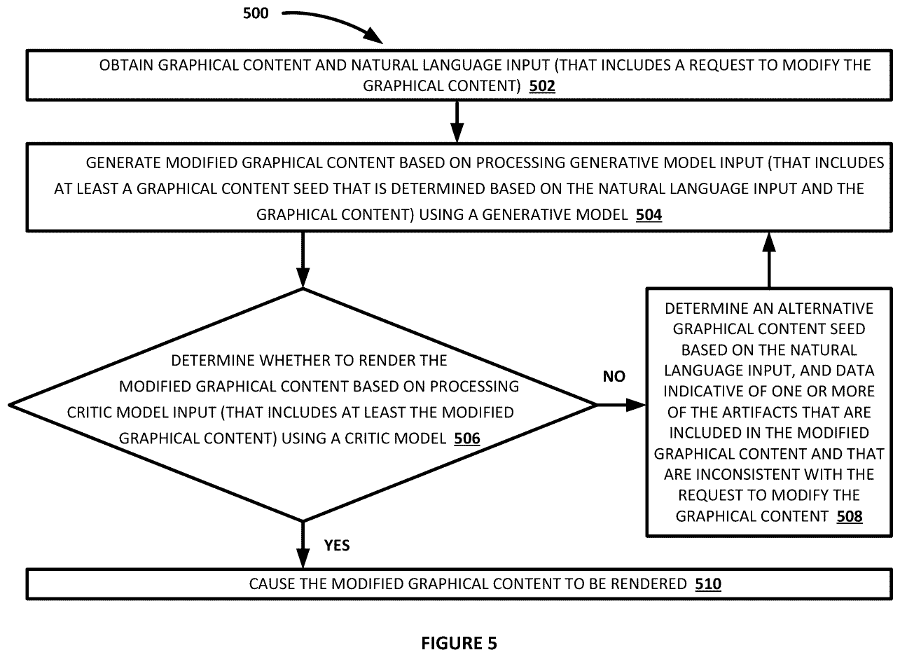

FIG. 5 depicts a flow chart 500 associated with implementations discussed herein. Aspects of flow chart 500 may be performed by a system that may include one or more components, such as client device 100, remote system 180, and/or another computing device. While operations of flow chart 500 are shown in a particular order, this is not meant to be limiting. One or more operations may be reordered, omitted, and/or added. Flow chart 400 and flow chart 500 may include one or more similar operations, however, one or more distinctions between flow chart 400 and flow chart 500 may exist, and may include obtaining graphical content in addition to natural language input, wherein the natural language user input includes a request to modify the graphical content.

At step 502, the system obtains graphical content and natural language input (that includes a request to modify the graphical content). For example, client device 100 may receive user input data 202 at I/O engine 102. User input data 202 may include natural language input and/or graphical content. As discussed in previous Figures (such as FIG. 2), client device 100 may also process and/or compress aspects of user input data 202. The user input may include graphical content (e.g., either captured concurrently with or prior to natural language input), and may include natural language input that includes a request to modify graphical content. The user input may include visual, haptic, and/or audio characteristics. The graphical content can include, for example, generative image(s) or video(s), non-generative image(s) or video(s) provided by the user, non-generative image(s) or video(s) linked-to by the user, etc.

For example, the system may capture a first portion of user input that is visually provided via a camera and the client device may capture a second portion of user input that is audibly provided via a microphone. User input may also be captured prior to invoking an automated assistant and selected subsequent to invoking the automated assistant. For example, the graphical content to be modified may have been captured prior to receiving the natural language request to modify the graphical content, and may be selected by a user. Put another way, in some implementations, user input may include selection by a user of one or more electronic components (e.g., images, requests, and/or suggestions, etc.) that may or may not have been generated in whole and/or in part prior to receiving the user input. As another example, in some implementations, client device 100 may concurrently capture graphical content and natural language user input to modify the graphical content (e.g., while one or more portions of the graphical content are being captured). Put another way, in some implementations, user input may include real-time capture of both graphical content and a request to modify graphical content, and the graphical content may or may not have been generated in whole and/or in part prior to receiving the user input.

In some implementations, processing user input may include processing contextual information associated with the user and/or the user input. For example, if graphical content (e.g., a bird bath) and/or natural language input (“render an image of that bird in this bird bath”) are captured concurrently in real-time, contextual information (such as background noise including a particular bird call) may be used in furtherance of modifying the graphical content. Put another way, user input data 202 may be processed in furtherance of rendering an image of the bird (associated with the background noise) being in the bird bath, as opposed to being processed in furtherance of rendering an image of a sports-mascot bird being in the bird bath. Turning briefly to FIG. 2, it is illustrated that I/O engine 102 may apply user input data 202 to one or more of user input engine 104 and/or context engine 106. Additionally, even if user input data 202 is not applied to context engine 106, I/O engine 102 may process user input data 202 using output from context engine 106, such as location data, user preferences, etc., which may be generally applicable and which may not be derived based on application of user input data 202 to context engine 106. Accordingly, I/O data 204 may be generated based on output from one or more of user input engine 104 and/or context engine 106, which user input data 202 may or may not be applied to.

Contextual information may be derived from data generated prior to receiving user input (e.g., user location, user preferences, user IDs, etc.), and/or may be derived from data generated subsequent to receiving user input. For example, data generated subsequent to receiving the user input may include data generated in response to applying user input data 202 to one or more application interfaces. Using the previous bird bath example, a user may have a generalized internet browser application on their device which may be used in furtherance of identifying a particular bird associated with a captured bird call, and/or the user may have a specific application on device which may be associated with a specific topic (e.g., bird call identification) which may be used in furtherance of identifying a particular bird associated with a captured bird call. Applications do not need to be on the user device that captured the user input. For example, a first user device may be a wearable computing device (e.g., glasses, watch, etc.), and a second user device may be a cellphone. The two devices may be connected over a network, and user input received at the first user device may be transmitted to the second user device, and contextual data may be generated based on one or more of an application and/or database of the second user device. Components discussed herein may be shared between the two devices, for example, the wearable computing device and the phone may share I/O engine 102, data compression engine 108, etc., and may be considered a single device from the perspective of remote system 180.

At step 504, the system generates modified graphical content based on processing generative model input (that includes at least a graphical content seed that is determined based on the natural language input and the graphical content) using a generative model. A graphical content seed may be generated or determined based on application of data (indicative of a user input and/or the graphical content) over a generative model input engine. For example, as discussed in FIGS. 2 and 3, generative model input engine 182 may receive compressed data 206 and/or user input data 202. Generative model input data 302 may include a graphical content seed that is determined based on at least the compressed data 206 and/or user input data 202. For example, generative model input engine 182 may apply compressed data 206 to natural language input engine 182A in furtherance of generating generative model input data 302 that may include a graphical content seed. As another example, generative model input engine 182 may apply compressed data 206 and/or user input data 202 to graphical input seed engine 182B in furtherance of generating generative model input data 302 that may include a graphical content seed.

Using the previous example, “render an image of that bird in this bird bath” (and/or contextual information) may be applied to natural language input engine 182A and graphical content, e.g., a picture, video, vector, etc. indicative of the bird bath (and/or contextual information) may be applied to the graphical input seed engine 182B. Generative model engine 184 may process generative model input data 302, which may include a graphical content seed, to generate generative model output data 304, which may include modified graphical content (and/or data that may be executed and/or processed in furtherance of rendering modified graphical content).

At step 506, the system determines whether to render the modified graphical content based on processing critic model input (e.g., that includes at least the generative model output data 304) using a critic model. If the system determines that the graphical content should be rendered, then flow chart 500 proceeds to step 510, and the system causes the graphical content to be rendered. For example, generative model output data 304 may be provided to critic engine 186 (and/or artifact detection engine 186A). If no issues (e.g., corruptions, artifacts, etc.) are identified by the critic engine 186, then graphical content data 208 (which may include generative model output data 304 and/or additional data) may be transmitted to client device 100. Remote system 180 may transmit graphical content data 208 to I/O engine 102 of client device 100, and I/O engine 102 may provide graphical content data 208 to action engine 110 which may cause the modified graphical content (derived from graphical content data 208) to be rendered via one or more interfaces of client device 100 and/or another client device.

In some implementations, the system determines that the modified graphical content should not be rendered, and flow chart 500 proceeds from step 506 to step 508. For example, generative model output data 304 may be provided to critic engine 186 (and/or artifact detection engine 186A). If issues (e.g., corruptions, artifacts, etc.) are identified by the critic engine 186 and/or artifact detection engine 186A, then the system may determine that modified graphical content should not be rendered. Further, if issues (e.g., corruptions, artifacts, etc.) are identified by the critic engine 186 and/or artifact detection engine 186A, then critic engine 186 may transmit data (which may include generative model output data 304, data indicating the issues, etc.) back to generative model input engine 182 and/or generative model engine 184. For example, critic engine 186 may provide generative output data 304—and/or data indicating issues included in generative output data 304 and/or issues that will be included in modified graphical content that may be rendered based on processing of generative output data 304—to generative model input engine 182 and/or generative model engine 184. Generative model input engine 182 may generate alternative generative model input data 302, including an alternative graphical content seed, based on the natural language input (and/or the graphical content), and/or based on the data received from critic engine 186.

Subsequent to performing features of step 508, flow chart 500 may proceed back to step 504. However, based on step 508 being performed, step 504 may be performed using the alternative modified graphical content seed, and step 504 may be performed in furtherance of generating alternative modified graphical content in lieu of the previously generated modified graphical content. For example, alternative modified graphical content may be generated based on processing generative model input that includes the alternative seed data. In some implementations, generative model engine 184 may also receive data from critic engine 186 (e.g., either directly, and/or vicariously via alternative generative model input data 302), and may be updated, biased, and/or trained, etc., based on the data received from critic engine 186. Put another way, critic engine 186 may provide data that may be used in furtherance of generating alternative seed data, and/or which may also be used in furtherance of training generative model(s).

Steps 504, 506, and/or 508 may be performed one or more times. By iteratively critiquing generative model output data 304, and/or updating generative model input data 302 and/or generative model engine(s) 184, modified graphical content may be generated more accurately, and unnecessary usage of computing resources and prolonging of human-to-computer dialogs may be resolved and/or mitigated. This reduces the likelihood and/or necessity for a user to provide additional inputs (thus re-initiating the whole of flow chart 500) to correct artifact(s) which would consume additional computing resources, such as those of client device 100 and/or remote system 180. As another example, the aggregate of users submitting one or more additional requests until the generated and/or modified graphical content is satisfactory may be resolved and/or mitigated based on iterative critique and regeneration (based on critique) of generative content - reducing extended and inconvenient user interactions that consume computing resources in furtherance of generating satisfactory graphical content.

As discussed above, during step 510 the system causes modified graphical content to be rendered. The system may cause the modified graphical content to be rendered based on a determination to render the modified graphical content (based on processing critic model input, that includes at least the modified graphical content, using a critic model), per step 506. The modified graphical content to be rendered may change based on processing of critic model input. Put another way, each iteration of steps 404 and/or 408 may result in data being generated, which when executed, causes particular and distinct modified graphical content to be rendered. For example, a first iteration of modified graphical content (if rendered) may include a person holding a peace sign and having two extra fingers and a disproportionately long nose (e.g., two artifacts), a second iteration of modified graphical content (e.g., alternative graphical content) may include the person holding the peace sign and having only one extra finger and a traditionally proportionate nose (e.g., one artifact), and a third iteration of modified graphical content (e.g., additional alternative graphical content) may include the person holding the peace sign (e.g., no artifacts). In the example of modified graphical content, user input data 202 may indicate user selection of an image (e.g., a friend with both hands in their pockets), and a natural language request to “please modify this photo so that the person is presenting a peace sign”. In some implementations, step 410 may include remote system 180 transmitting graphical content data to client device 100, which may receive the graphical content data 208 at I/O engine 102 and may cause modified graphical content to be rendered via one or more interfaces based on action engine 110 processing graphical content data 208.

Although FIG. 5 depicts the flow chart 500 being executed for any natural language input that includes a request to generate graphical content, it should be understood that is for the sake of example and is not meant to be limiting. For example, like the operations of FIG. 4, the operations of FIG. 5 may only be executed in certain situations, such as when the natural language input includes a request for realistic graphical content. For instance, had the natural language input included a request to modify an image of an alien or other science fiction topic, then the steps of 506 and 508 may be omitted such that an image of an alien having six fingers and an elongated nose could be rendered. In these implementations, the system can optionally use a ML-based classifier or other approach to determine whether to include the steps of 406 and 408. Additionally, or alternatively, one or more terms included in the user input can explicitly override utilization of the ML-based classifier (e.g., user input that states “include a person with six fingers” can override utilization of the ML-based classifier, etc.).

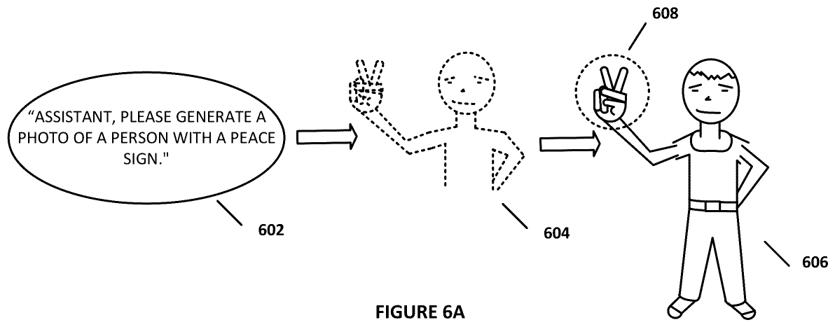

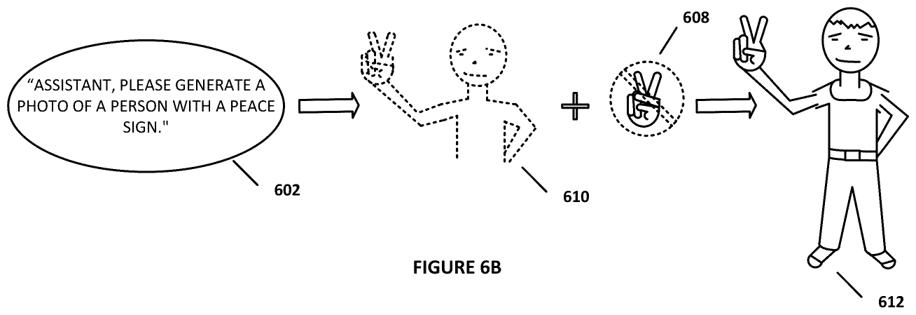

FIG. 6A depicts an environment in which a first iteration of graphical content is generated based on a natural language user request. User input 602 may be received at one or more client devices and may include a natural language input. The natural language input may include a request for generation of graphical content. For example, a request for generation of graphical content may include, e.g., “assistant, please generate a photo of a person with a peace sign”.

Seed representation 604 is a graphical representation of at least a portion of generative model input data. Notably, in some implementations, seed representation 604 is provided as an example of a graphical depiction of generative model input data for illustrative purposes and may not include any human perceptible information (e.g., seed representation 604 may be random noise). However, in additional or alternative implementations, seed representations 604 may include one or more basic features (e.g., as shown in FIG. 6A), such as a head, torso, arm(s), leg(s), etc.

Referring briefly to FIG. 3, recall that generative model input data 302 may be applied to generative model(s) in furtherance of outputting generative model output data 304. In the example of FIG. 6A, generative model input data (e.g., that includes user input 602 and seed representation 604) can be processed, using generative model(s), to generate generative model output data based on which generative model output representation 606 is determined. Generative model output representation 606 is a graphical representation of generative model output data. Further, generative model output representation 606 includes a head, torso, first arm behind a back, and second arm with a hand including a peace sign representation, which are determined based on user input 602 and using seed representation 604. In this iteration, generative model output representation 606 also includes an artifact 608 of two thumbs being included on the hand giving the peace sign. As discussed herein, artifacts, data corruptions, etc., may be identified by critic engine 186 and/or artifact detection engine 186A, and one or more additional iterations of generative model input data and/or generative model output data may be generated, processed, and/or transmitted based on critic model output, generated using critic engine 186, indicating that generative model output representation 606 includes an artifact (e.g., the two thumbs being included on the hand giving the peace sign).

FIG. 6B depicts an environment in which a second iteration of graphical content is generated based on the natural language user request. As indicated in FIG. 6A, user input 602 may be received at one or more client devices and may include a natural language input. The natural language input may include a request for generation of graphical content. For example, a request for generation of graphical content may include, e.g., “assistant, please generate a photo of a person with a peace sign”.

Based on the critic model output indicating generative model output representation 606 includes an artifact 608 (e.g., the two thumbs being included on the hand giving the peace sign), alternative generative model input data may be generated. Alternative generative model input data may include user input 602, alternative seed representation 610 (e.g., that differs from seed representation 604), and/or an indication of artifact 608. Alternative generative model output data (graphically represented by generative model output representation 612) may not include artifact 608 based on one or more of critic engine 186 output and/or alternative generative model input data (graphically represented by alternative seed representation 610). Accordingly, extended interaction by the user with one or more of client device 100 and/or remote system 180 may be mitigated and/or omitted, and extended consumption of computing resources associated therewith may also be mitigated and/or omitted, thereby creating benefits of increased computational efficiency and improved user interactions.

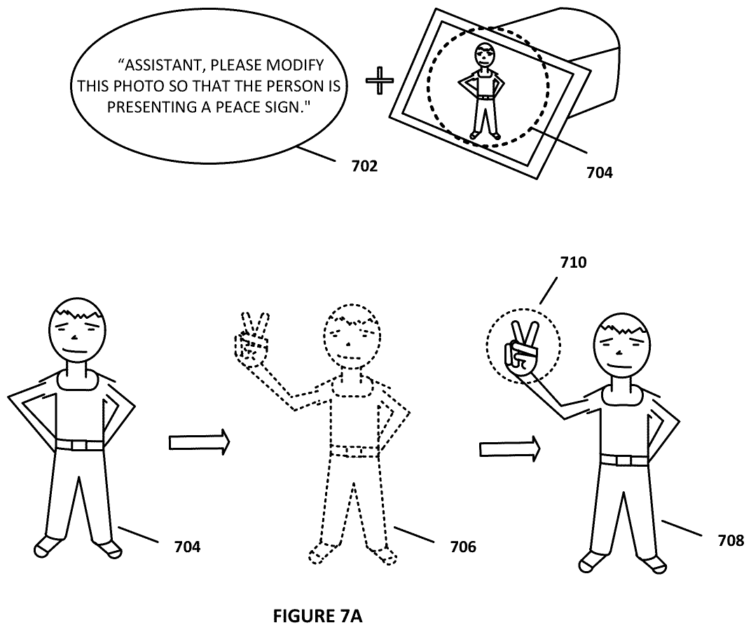

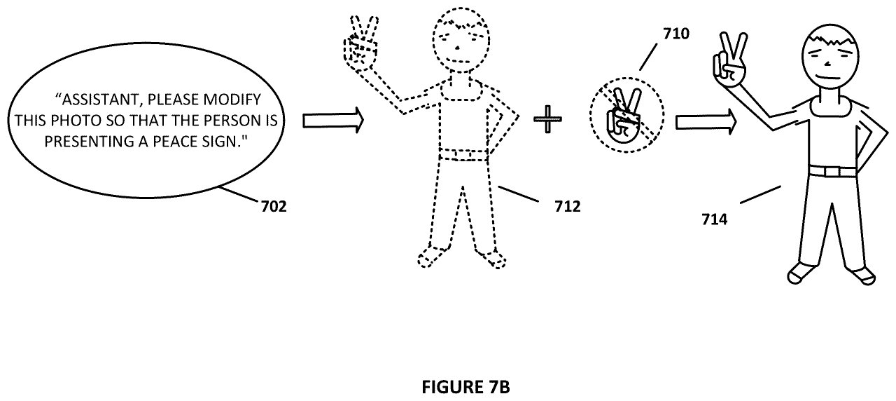

FIG. 7A depicts an environment in which graphical content and natural language user input is provided, and a first iteration of modified graphical content is generated. Natural language input 702 and graphical content 704 may be received at one or more client devices. The natural language input 702 may include a request for modification of the graphical content 704. For example, a request for modification of graphical content 704 may include, e.g., “assistant, please modify this photo so that the person is presenting a peace sign”. In this example, graphical content 704 includes a person who has each hand behind their back.

Seed representation 706 is a graphical representation of at least a portion of generative model input data. Notably, in some implementations, seed representation 706 is provided as an example of a graphical depiction of generative model input data for illustrative purposes and may not include any human perceptible information (e.g., seed representation 706 may be random noise). However, in additional or alternative implementations, seed representations 706 may include one or more basic features (e.g., as shown in FIG. 7A), such as a head, torso, arm(s), leg(s), etc. that may optionally be based on graphical content 704 that was provided.

For instance, in these additional or alternative implementations and referring briefly to the environment of FIGS. 6A-6B, user input 602 may not include graphical content, and therefore seed representation 604 may not initially be as detailed as the seed representation 706 depicted in FIG. 7A. Put another way, graphical content 704, of FIG. 7A, may be used in furtherance of generating generative model input data, and may result in generative model input data including more detail relative to seed data that may be generated without provision of graphical content. Accordingly, seed representation 604 of FIGS. 6A-6B may or may not be less detailed relative to seed representation 706 of FIG. 7A.

Referring briefly to FIG. 3, recall that generative model input data 302 may be applied to generative model(s) in furtherance of outputting generative model output data 304. In the example of FIG. 7A, generative model input data (e.g., that includes user input 702 and seed representation 706 (and optionally graphical content 704)) can be processed, using generative model(s), to generate generative model output data based on which generative model output representation 708 is determined. Generative model output representation 708 is a graphical representation of generative model output data. Further, generative model output representation 708 includes a head, torso, first arm behind a back, and second arm with a hand including a peace sign representation, which are determined based on user input 702 and graphical content. In this iteration, generative model output representation 708 also includes an artifact 710 of two thumbs being included on the hand giving the peace sign. As discussed herein, artifacts, data corruptions, etc., may be identified by critic model engine 186 and/or artifact detection engine 186A, and one or more additional iterations of generative model input data and/or generative model output data may be generated, processed, and/or transmitted based on critic model output, generated using critic engine 186, indicating that generative model output representation 606 includes an artifact (e.g., the two thumbs being included on the hand giving the peace sign).

Similar to seed representation 706, generative model output representation 708 may or may not be rendered graphically in various implementations, but generative model output representation 708 is provided as an example of a graphical depiction of generative model output data for illustrative purposes. Put another way, remote system 180 may or may not cause generative model output representation 708 to be rendered at one or more interfaces, and/or virtually rendered in furtherance of generating, processing, and/or transmitting generative model output representation 708.

FIG. 7B depicts an environment in which graphical content and natural language user input is provided, and a second iteration of modified graphical content is generated. As indicated in FIG. 7A, natural language input 702 and graphical content 704 may be received at one or more client devices. The natural language input may include a request for modification of the graphical content 704. For example, a request for modification of graphical content may include, e.g., “assistant, please modify this photo so that the person is presenting a peace sign”.

Based on the critic model output indicating generative model output representation 708 includes an artifact 710 (e.g., the two thumbs being included on the hand giving the peace sign), alternative generative model input data may be generated. Alternative generative model input data may include user input 702, alternative seed representation 712 (e.g., that differs from seed representation 706), and/or an indication of artifact 710. Alternative generative model output data (graphically represented by generative model output representation 714) may not include artifact 710 based on one or more of critic engine 186 output and/or alternative generative model input data (graphically represented by alternative seed representation 712). Accordingly, extended interaction by the user with one or more of client device 100 and/or remote system 180 may be mitigated and/or omitted, and extended consumption of computing resources associated therewith may also be mitigated and/or omitted, thereby creating benefits of increased computational efficiency and improved user interactions.

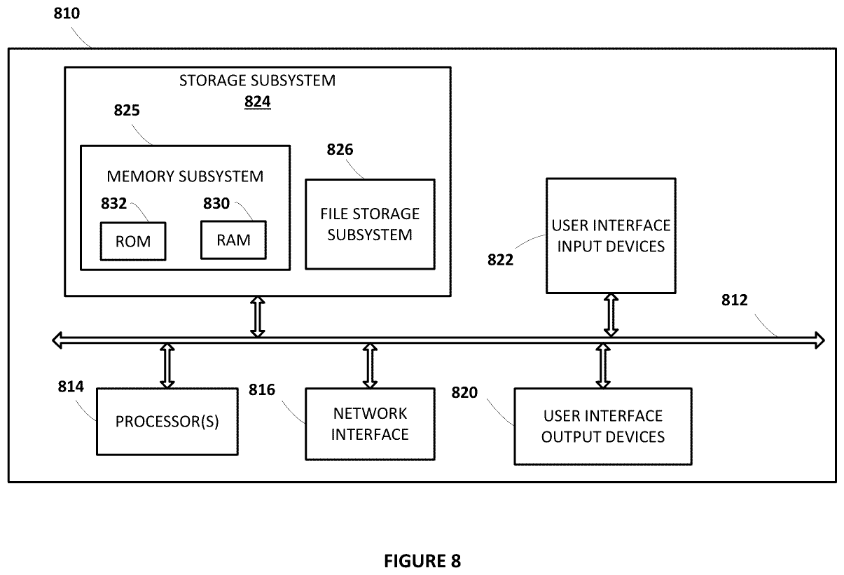

Turning now to FIG. 8, a block diagram of an example computing device 810 that may optionally be utilized to perform one or more aspects of techniques described herein. In some implementations, one or more of a client device, remote system component(s), and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the methods disclosed herein, as well as to implement various components depicted in other figures.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving natural language input that is associated with a computing device of a user, the natural language input including a request to generate graphical content; and generating, based on processing generative model input using a generative model, the graphical content. The generative model input includes at least a graphical content seed that is determined based on the natural language input. The method further includes determining, based on processing critic model input using a critic model, whether to render the graphical content. The critic model input includes at least the graphical content, and determining whether to render the graphical content based on processing the graphical content using the critic model includes: processing, using the critic model, the critic model input to determine whether the graphical content includes one or more artifacts that are inconsistent with the request to generate the graphical content; and determining, based on whether the graphical content includes one or more of the artifacts that are inconsistent with the request to generate the graphical content, whether to render the graphical content. The method further includes, in response to determining to refrain from rendering the graphical content: generating, based on processing additional generative model input and using the generative model or an additional generative model, alternative graphical content; determining, based on processing additional critic model input using the critic model, whether to render the alternative graphical content; and in response to determining to render the alternative graphical content: causing the alternative graphical content to be rendered at an interface of the computing device of the user. The additional generative model input includes at least an alternative graphical content seed, that is also determined based on the natural language input, and data indicative of one or more of the artifacts that are inconsistent with the request to generate the graphical content, and the additional critic model input includes at least the alternative graphical content.

These and other implementations of technology disclosed herein can optionally include one or more of the following features.

In some implementations, determining whether to render the alternative graphical content based on processing the alternative graphical content using the critic model can include: processing, using the critic model, the additional critic model input to determine whether the alternative graphical content includes one or more artifacts that are inconsistent with the request to generate the graphical content; and determining, based on whether the alternative graphical content includes one or more of the artifacts that are inconsistent with the request to generate the graphical content, whether to render the alternative graphical content.

In some implementations, the method can further include, prior to determining whether to render the graphical content: identifying, based on processing the natural language input of the user, that one or more of the artifacts are referenced in the natural language input of the user; and determining, based on identifying that one or more of the artifacts are referenced in the natural language input of the user, to modify the critic model. Determining whether the graphical content includes one or more artifacts that are inconsistent with the request to generate the graphical content can be based on determining to modify the critic model.

In some versions of those implementations, the natural language input of the user can also include an explicit request that one or more of the artifacts be included in the graphical content. The artifacts can be graphical deviations from a graphical standard that is derived by processing training data using the critic model.

In additional or alternative versions of those implementations, determining whether the graphical content includes one or more artifacts that are inconsistent with the request to generate the graphical content can include: identifying whether the graphical content includes a first subset of the one or more artifacts which are inconsistent with the request to generate the graphical content, identifying whether the graphical content includes a second subset of the one or more artifacts which are inconsistent with the request to generate the graphical content, and in response to modifying the critic model: determining, based on modifying the critic model, to ignore only the first subset of the one or more artifacts which are inconsistent with the critic model. Determining whether the graphical content includes one or more artifacts that are inconsistent with the request to generate the graphical content is based on identifying whether the graphical content includes the second subset.

In some implementations, the method can further include, prior to determining whether to render the graphical content: identifying, based on processing the natural language input of the user, that one or more of the artifacts are referenced in the natural language input of the user; and determining, based on identifying that one or more of the artifacts are referenced in the natural language input of the user, to ignore the critic model. Determining whether the graphical content includes one or more artifacts that are inconsistent with the request to generate the graphical content can be based on determining to ignore the critic model.

In some implementations, the method can further include, in response to determining to refrain from rendering the graphical content: causing, based on applying the data indicative of the one or more artifacts to the generative model, the generative model to be updated.

In some versions of those implementations, causing the generative model to be updated can occur prior to generating the alternative graphical content, and the graphical content and the data indicative of the one or more artifacts can be applied only to the generative model.

In additional or alternative versions of those implementations, causing the generative model to be updated can occur subsequent to generating the alternative graphical content, the graphical content and the data indicative of the one or more artifacts can be applied only to the additional generative model.

In some implementations, the natural language input can be spoken input and/or typed input.

In some implementations, a method implemented by one or more processors is provided, and includes: obtaining, from a user of a computing device, graphical content and natural language input, the natural language input including a request to modify the graphical content; and generating, based on processing generative model input using a generative model, modified graphical content. The generative model input includes at least a graphical content seed that is determined based on the natural language input and the graphical content. The method further includes determining, based on processing critic model input using a critic model, whether to render the modified graphical content. The critic model input includes at least the modified graphical content, and determining whether to render the modified graphical content based on processing the modified graphical content using the critic model includes: processing, using the critic model, the critic model input to determine whether the modified graphical content includes one or more artifacts that are inconsistent with the request to modify the modified graphical content; and determining, based on whether the modified graphical content includes one or more of the artifacts that are inconsistent with the request to modify the graphical content, whether to render the modified graphical content. The method further includes, in response to determining to refrain from rendering the modified graphical content: generating, based on processing additional generative model input and using the generative model or an additional generative model, alternative modified graphical content; determining, based on processing additional critic model input using the critic model, whether to render the alternative modified graphical content; and in response to determining to render the alternative modified graphical content: causing the alternative modified graphical content to be rendered at an interface of the computing device of the user. The additional generative model input includes at least an alternative graphical content seed, that is also determined based on the natural language input, and data indicative of one or more of the artifacts that are inconsistent with the request to modify the graphical content, and the additional critic model input includes at least the alternative modified graphical content.

These and other implementations of technology disclosed herein can optionally include one or more of the following features.

In some implementations, determining whether to render the alternative modified graphical content based on processing the alternative modified graphical content using the critic model can include: processing, using the critic model, the additional critic model input to determine whether the alternative modified graphical content includes one or more artifacts that are inconsistent with the request to modify the graphical content; and determining, based on whether the alternative modified graphical content includes one or more of the artifacts that are inconsistent with the request to modify the graphical content, whether to render the alternative modified graphical content.

In some implementations, the method can further include, prior to determining whether to render the modified graphical content: obtaining natural language input from the user of the computing device; identifying, based on processing the natural language input of the user, that one or more of the artifacts are referenced in the natural language input of the user; and determining, based on identifying that one or more of the artifacts are referenced in the natural language input of the user, to modify the critic model. Determining whether the modified graphical content includes one or more artifacts that are inconsistent with the request to modify the graphical content is based on determining to modify the critic model.

In some versions of those implementations, the natural language input of the user can also include an explicit request that one or more of the artifacts be included in a modification of the graphical content, the artifacts can be graphical deviations from a graphical standard that is derived by processing training data using the critic model, and the modification of the graphical content can be included in at least one or more of the modified graphical content or the alternative modified graphical content.

In additional or alternative versions of those implementations, determining whether the modified graphical content includes one or more artifacts that are inconsistent with the request to generate the graphical content can include: identifying whether the modified graphical content includes a first subset of the one or more artifacts which are inconsistent with the request to modify the graphical content; identifying whether the modified graphical content includes a second subset of the one or more artifacts which are inconsistent with the request to modify the graphical content; and in response to modifying the critic model: determining, based on modifying the critic model, to ignore only the first subset of the one or more artifacts which are inconsistent with the critic model. Determining whether the modified graphical content includes one or more artifacts that are inconsistent with the request to modify the graphical content can be based on identifying whether the modified graphical content includes the second subset.

In some implementations, the method can further include, prior to determining whether to render the modified graphical content: obtaining natural language input from the user of the computing device; identifying, based on processing the natural language input of the user, that one or more of the artifacts are referenced in the natural language input of the user; and determining, based on identifying that one or more of the artifacts are referenced in the natural language input of the user, to ignore the critic model. Determining whether the modified graphical content includes one or more artifacts that are inconsistent with the request to modify the graphical content can be based on determining to ignore the critic model.

In some implementations, the method can further include, in response to determining to refrain from rendering the modified graphical content: causing, based on applying the data indicative of the one or more artifacts to the generative model, the generative model to be updated.

In some versions of those implementations, causing the generative model to be updated can occur prior to generating the alternative modified graphical content, and the modified graphical content and the data indicative of the one or more artifacts can be applied only to the generative model.

In additional or alternative versions of those implementations, causing the generative model to be updated can occur subsequent to generating the alternative modified graphical content, and the modified graphical content and the data indicative of the one or more artifacts can be applied only to the additional generative model.

In some implementations, the natural language input can be spoken input and/or typed input.

In addition, some implementations include systems having one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to execute any of the aforementioned instructions. Some implementations also include one or more non-transitory computer readable storage media storing computer instructions executable by one or more processors to perform any of the aforementioned instructions. Some implementations also include a computer program product including instructions executable by one or more processors to perform any of the aforementioned instructions. Some implementations also include a method implemented by one or more processors to perform any of the steps of the aforementioned instructions.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving natural language input that is associated with a computing device of a user, the natural language input including a request to generate graphical content;
generating, based on processing generative model input using a generative model, the graphical content, wherein the generative model input includes at least a graphical content seed that is determined based on the natural language input;
determining, based on processing critic model input using a critic model, whether to render the graphical content, wherein the critic model input includes at least the graphical content, and wherein determining whether to render the graphical content based on processing the graphical content using the critic model comprises:
processing, using the critic model, the critic model input to determine whether the graphical content includes one or more artifacts that are inconsistent with the request to generate the graphical content; and
determining, based on whether the graphical content includes one or more of the artifacts that are inconsistent with the request to generate the graphical content, whether to render the graphical content;
in response to determining to refrain from rendering the graphical content:
generating, based on processing additional generative model input and using the generative model or an additional generative model, alternative graphical content,
wherein the additional generative model input includes at least an alternative graphical content seed, that is also determined based on the natural language input, and data indicative of one or more of the artifacts that are inconsistent with the request to generate the graphical content;
determining, based on processing additional critic model input using the critic model, whether to render the alternative graphical content, wherein the additional critic model input includes at least the alternative graphical content; and
in response to determining to render the alternative graphical content:
causing the alternative graphical content to be rendered at an interface of the computing device of the user.

2. The method of claim 1, wherein determining whether to render the alternative graphical content based on processing the alternative graphical content using the critic model comprises:
processing, using the critic model, the additional critic model input to determine whether the alternative graphical content includes one or more artifacts that are inconsistent with the request to generate the graphical content; and
determining, based on whether the alternative graphical content includes one or more of the artifacts that are inconsistent with the request to generate the graphical content, whether to render the alternative graphical content.

3. The method of claim 1, further comprising:
prior to determining whether to render the graphical content:
identifying, based on processing the natural language input of the user, that one or more of the artifacts are referenced in the natural language input of the user; and
determining, based on identifying that one or more of the artifacts are referenced in the natural language input of the user, to modify the critic model,
wherein determining whether the graphical content includes one or more artifacts that are inconsistent with the request to generate the graphical content is based on determining to modify the critic model.

4. The method of claim 3, wherein the natural language input of the user also includes an explicit request that one or more of the artifacts be included in the graphical content, wherein the artifacts are graphical deviations from a graphical standard that is derived by processing training data using the critic model.

5. The method of claim 3, wherein determining whether the graphical content includes one or more artifacts that are inconsistent with the request to generate the graphical content comprises:
identifying whether the graphical content includes a first subset of the one or more artifacts which are inconsistent with the request to generate the graphical content;
identifying whether the graphical content includes a second subset of the one or more artifacts which are inconsistent with the request to generate the graphical content, and
in response to modifying the critic model:
determining, based on modifying the critic model, to ignore only the first subset of the one or more artifacts which are inconsistent with the critic model,
wherein determining whether the graphical content includes one or more artifacts that are inconsistent with the request to generate the graphical content is based on identifying whether the graphical content includes the second subset.

6. The method of claim 1, further comprising:
prior to determining whether to render the graphical content:
identifying, based on processing the natural language input of the user, that one or more of the artifacts are referenced in the natural language input of the user; and
determining, based on identifying that one or more of the artifacts are referenced in the natural language input of the user, to ignore the critic model,
wherein determining whether the graphical content includes one or more artifacts that are inconsistent with the request to generate the graphical content is based on determining to ignore the critic model.

7. The method of claim 1, further comprising:
in response to determining to refrain from rendering the graphical content:
causing, based on applying the data indicative of the one or more artifacts to the generative model, the generative model to be updated.

8. The method of claim 7, wherein causing the generative model to be updated occurs prior to generating the alternative graphical content, and wherein the graphical content and the data indicative of the one or more artifacts is applied only to the generative model.

9. The method of claim 7, wherein causing the generative model to be updated occurs subsequent to generating the alternative graphical content, and wherein the graphical content and the data indicative of the one or more artifacts is applied only to the additional generative model.

10. The method of claim 1, wherein the natural language input is spoken input and/or typed input.

11. A method implemented by one or more processors, the method comprising:
obtaining, from a user of a computing device, graphical content and natural language input, the natural language input including a request to modify the graphical content;
generating, based on processing generative model input using a generative model, modified graphical content, wherein the generative model input includes at least a graphical content seed that is determined based on the natural language input and the graphical content;
determining, based on processing critic model input using a critic model, whether to render the modified graphical content, wherein the critic model input includes at least the modified graphical content, and wherein determining whether to render the modified graphical content based on processing the modified graphical content using the critic model comprises:
processing, using the critic model, the critic model input to determine whether the modified graphical content includes one or more artifacts that are inconsistent with the request to modify the modified graphical content; and
determining, based on whether the modified graphical content includes one or more of the artifacts that are inconsistent with the request to modify the graphical content, whether to render the modified graphical content;
in response to determining to refrain from rendering the modified graphical content:
generating, based on processing additional generative model input and using the generative model or an additional generative model, alternative modified graphical content, wherein the additional generative model input includes at least an alternative graphical content seed, that is also determined based on the natural language input, and data indicative of one or more of the artifacts that are inconsistent with the request to modify the graphical content;
determining, based on processing additional critic model input using the critic model, whether to render the alternative modified graphical content, wherein the additional critic model input includes at least the alternative modified graphical content; and
in response to determining to render the alternative modified graphical content:
causing the alternative modified graphical content to be rendered at an interface of the computing device of the user.

12. The method of claim 11, wherein determining whether to render the alternative modified graphical content based on processing the alternative modified graphical content using the critic model comprises:
processing, using the critic model, the additional critic model input to determine whether the alternative modified graphical content includes one or more artifacts that are inconsistent with the request to modify the graphical content; and
determining, based on whether the alternative modified graphical content includes one or more of the artifacts that are inconsistent with the request to modify the graphical content, whether to render the alternative modified graphical content.

13. The method of claim 1, further comprising:
prior to determining whether to render the modified graphical content:
obtaining natural language input from the user of the computing device;
identifying, based on processing the natural language input of the user, that one or more of the artifacts are referenced in the natural language input of the user; and
determining, based on identifying that one or more of the artifacts are referenced in the natural language input of the user, to modify the critic model,
wherein determining whether the modified graphical content includes one or more artifacts that are inconsistent with the request to modify the graphical content is based on determining to modify the critic model.

14. The method of claim 13, wherein the natural language input of the user also includes an explicit request that one or more of the artifacts be included in a modification of the graphical content, wherein the artifacts are graphical deviations from a graphical standard that is derived by processing training data using the critic model, and wherein the modification of the graphical content is included in at least one or more of the modified graphical content or the alternative modified graphical content.

15. The method of claim 13, wherein determining whether the modified graphical content includes one or more artifacts that are inconsistent with the request to generate the graphical content comprises:
identifying whether the modified graphical content includes a first subset of the one or more artifacts which are inconsistent with the request to modify the graphical content;
identifying whether the modified graphical content includes a second subset of the one or more artifacts which are inconsistent with the request to modify the graphical content; and
in response to modifying the critic model:
determining, based on modifying the critic model, to ignore only the first subset of the one or more artifacts which are inconsistent with the critic model,
wherein determining whether the modified graphical content includes one or more artifacts that are inconsistent with the request to modify the graphical content is based on identifying whether the modified graphical content includes the second subset.

16. The method of claim 1, further comprising:
prior to determining whether to render the modified graphical content:
obtaining natural language input from the user of the computing device;
identifying, based on processing the natural language input of the user, that one or more of the artifacts are referenced in the natural language input of the user; and
determining, based on identifying that one or more of the artifacts are referenced in the natural language input of the user, to ignore the critic model,
wherein determining whether the modified graphical content includes one or more artifacts that are inconsistent with the request to modify the graphical content is based on determining to ignore the critic model.

17. The method of claim 11, further comprising:
in response to determining to refrain from rendering the modified graphical content:
causing, based on applying the data indicative of the one or more artifacts to the generative model, the generative model to be updated.

18. The method of claim 17, wherein causing the generative model to be updated occurs prior to generating the alternative modified graphical content, and wherein the modified graphical content and the data indicative of the one or more artifacts is applied only to the generative model.

19. The method of claim 17, wherein causing the generative model to be updated occurs subsequent to generating the alternative modified graphical content, and wherein the modified graphical content and the data indicative of the one or more artifacts is applied only to the additional generative model.

20. The method of claim 11, wherein the natural language input is spoken input and/or typed input.
